(19) United States
(12) Patent Application Publication
(10) Pub. No.: US 2014/0224512 A1
(43) Pub. Date: Aug. 14, 2014

(54) AERATION TINES AND METHODS OF MAKING AERATION TINES

(71) Applicant: ENDURATECH MANUFACTURING, LLC, Tampa, FL (US)

(72) Inventors: Habib Skaff, Tampa, FL (US); Clayton Ross, Tampa, FL (US); Charles Paquette, Tampa, FL (US)

(73) Assignee: Enduratech Manufacturing, LLC, Tampa, FL (US)

(21) Appl. No.: 13/766,729

(22) Filed: Feb. 13, 2013

(51) Int. Cl. A01B 45/02

(52) U.S. Cl. CPC A01B 45/02
USPC 172/1; 172/22; 148/279

(57) ABSTRACT

An aeration tine includes a non-boronized elongated body including a first longitudinal end configured to support the tine relative to an aeration machine, and a second longitudinal end opposite the first longitudinal end, and a tapered nose attached to the second longitudinal end of the non-boronized elongated body, the tapered nose formed of a metal base treated by a boronization process such that the tapered nose has a an outer layer that is hardened relative to an inner portion of the metal base.

### FIELD OF THE INVENTION

The present disclosure relates generally to aeration tines and methods of making aeration tines. More specifically, the present disclosure relates to wear-resistant aeration tines and a methods of fabricating wear-resistant aeration tines.

### BACKGROUND

Soil aeration is a process by which soil is cultivated to broaden and improve the contact between air, water and soil either naturally or mechanically. The term aeration commonly refers to a procedure or method of using an aeration machine, a mechanized device, to cultivate the turf. Aeration machines use aeration tine devices to slice channels in the soil or to puncture the turf to remove soil or thatch. Aeration is an elemental and customary method that can improve natural soil aeration, gas exchange, water penetration and/or prevent or relieve turf compaction.

Aerator machines are plentiful and the aeration tine devices are vast. Aeration tine devices are described, for example, in U.S. Pat. Nos. D,638,862, 4,662,456, 4,723,607, 4,773,486, 4,785,889, 4,881,602, 4,924,944, 5,469,922, 5,495,895, 5,690,179, 5,816,336, 6,505,687, 6,513,603, 6,691,791, 6,945,332, 6,983,806, 7,096,968, 7,152,691, 7,438,136 7,484,568 7,640,994, 7,874,374, and 8,220,557. The repeated insertion into the turf and resulting friction causes the aeration tine device tip to undergo wear which changes the length and diameter of the aeration tine device. As a result, the aerator machine operator is required to stop the aerator machine and replace the worn-out aerator tine device with a new aerator tine device to continue the aeration. These change-outs are costly and time-consuming

To increase durability of the aeration tine device, carbide tip aeration tine devices have been introduced, such as described, for example, in U.S. Patent Application Serial No. 2005/0167126. Although carbide tip aeration tine devices are more durable than the conventional aeration tine devices, they are problematic because the tip of the carbide tip aeration tine device is dull and the resulting hole is ripped with a slight depression around the lip of the hole, which prolongs the grow-in of the turf. Additionally, the carbide tip of the carbide tip aeration device is brittle and the repeated insertion of carbide tip aeration tine device results in the separation or chipping off of the carbide tip and uneven wear.

Because there is a need for a durable aeration tine device that reduces the problems posed by carbide tip aeration tine devices, a borided aeration tine has been developed, such as the Phoenix™ tine marketed by Ceres Turf, Inc.

Boriding is known to increase wear-resistance in metallic surfaces. It is not a new surface hardening technique and there are various methods of boronizing metallic surfaces. Such methods produce a boron layer on a metal surface. Typically, these methods utilize reactive boron species which diffuse into the metal surface and result in increased useable life of the wearing parts.

As compared to the non-treated aeration tine devices, borided aeration tine devices are believed to last 300-500% longer in the field. As compared to a carbide tip aeration tine device, a borided aeration tine device may have a wear resistance comparable to the carbide tip aeration tine device and may result in a cleaner, sharper hole that shortens the turf grow-in time.

A borided aeration tine device also does not wear out like the brittle carbide tip aeration device. Typically carbide tip aeration devices fail when the carbide tip separates or chips off or when repeated insertion into the turf results in the diameter or inner wall wearing out. In contrast, the inner walls of a borided aeration tine device only fractionally wear out in comparison to a carbide tip aeration tine device.

Additionally, as a result of how the inner wall wears out on a carbide tip aeration tine device, the design of a carbide tip aeration tine device is limited to thicker-walled aeration tine devices. The borided aeration tine device can support a much thinner inner wall and therefore, a much wider design range. For example, the borided tine may have a wall thickness of 0.07 inches or less, 0.065 inches or less, 0.0625 inches or less, or 0.050 inches or less.

Common practice in boriding aeration tine devices is to fabricate the aeration tine device as one piece and then boride the whole aeration tine device. Boriding aeration tines in this manner can be costly because of, e.g., the amount of boriding material used to treat the entire tine aeration device. It is also problematic because the extreme temperatures required to boride, coupled with the weight of the aeration tine device, results in shape distortion, deformation, warping and/or bending of the aeration tine device. This problem is especially acute in smaller-diameter coring and quad aeration tines (tine devices with hollow type can be found in, e.g., U.S. Pat. Nos. 4,924,944 and 5,495,895), because of the thinner inner diameter walls and hollow elongated portions. Attempts at controlling shape distortion through temperature control have been unsuccessful. As a result, it is desirable to find a more advantageous and cost-effective way to use boriding to increase the useable lifetime of an aeration tine device tip without the resulting shape distortion, deformation, warping or bending of the entire aeration tine device.

U.S. Patent Application Serial No. 2005/0167126 describes an aeration tine device that couples a tungsten carbide, titanium carbide, or cermet tip to a steel-based shaft. The tip is formed by a sintering process, and the resulting tip is brazed to the steel shaft. This process results in deficiencies. For example, this sintering process results in parts that are not particularly sharp, thereby resulting in the poor puncturing and associated problems discussed above.

Thus, there is a need for an aeration tine having the benefits of boronized steel without resulting shape distortion, deformation, warping or bending of the overall tine device.

### SUMMARY

In accordance with example embodiments of the present invention, an aeration tine includes: a non-boronized elongated body including a first longitudinal end configured to support the tine relative to an aeration machine, and a second longitudinal end opposite the first longitudinal end; and a tapered nose attached to the second longitudinal end of the non-boronized elongated body, the tapered nose formed of a metal base treated by a boronization process such that the tapered nose has a an outer layer that is hardened relative to an inner portion of the metal base.

The non-boronized elongated body and/or the nose may be heat treated.

The entire aeration tine may be heat treated.

The metal base may be comprised of a ferrous alloy, which may be, e.g., steel.

The metal base may be comprised of a non-ferrous alloy, e.g., a copper alloy or a titanium alloy.

The tapered nose may be welded, brazed, and/or soldered to the non-boronized elongated body.

The tapered nose may be fixedly attached to the non-boronized elongated body.

The tapered nose may be attached to the non-boronized elongated body via a threaded connection such that the tapered nose is screwed onto the non-boronized elongated body.

The first longitudinal end may include a shank having a reduced diameter relative to other portions of the non-boronized elongated body, the shank configured for insertion into an aeration machine.

The aeration tine may be hollow.

The non-boronized elongated body may include a longitudinal opening for ejection of soil plugs during an aeration process.

The aeration tine may be solid (not hollow; not having an opening into which a soil plug is received during operation).

The nose of the aeration tine may have a Vickers HV₅₀ as measured (ASTM E 384-99^{E1}, Vickers indenter, 50 g load) at a depth of 0.0015″ below the surface to be, e.g., greater than 1000 Vickers, greater than 1100 Vickers, greater than 1200 Vickers, greater than 1300 Vickers, greater than 1400 Vickers, greater than 1500 Vickers, greater than 1600 Vickers, greater than 1700 Vickers, greater than 1800 Vickers, greater than 1900 Vickers, greater than 2000 Vickers, or any other suitable hardness.

Further, the nose of the aeration tine may have an effective case depth greater than 0.080″, greater than 0.090″, greater than 0.0100″, greater than 0.0110″, greater than 0.0120″, greater than 0.0130″, greater than 0.0140″, greater than 0.0150″, or any other suitable effective case depth.

In accordance with example embodiments of the present invention, an aeration machine configured to aerate soil includes the aeration tine.

In accordance with example embodiments of the present invention, a method includes aerating soil with the aeration tine.

In accordance with example embodiments of the present invention a method of making an aeration tine includes: boronizing a metal tapered nose such that the tapered nose has a an outer metal layer that is hardened relative to an inner metal portion of the tapered nose; and attaching the boronized tapered nose to a second longitudinal end of a non-boronized elongated body, the non-boronized elongated body having a first longitudinal end configured to support the tine relative to an aeration machine, the first longitudinal end being disposed opposite the second longitudinal end.

The method may further include heat treating the boronized tapered nose and the non-boronized elongated body after the boronized tapered nose and the non-boronized elongated body are connected.

The connecting may include welding, brazing, and/or soldering the boronized tapered nose to the non-boronized elongated body.

The attaching the boronized tapered nose to the second longitudinal end of a non-boronized elongated body includes screwing the boronized tapered nose onto the non-boronized elongated body via a threaded connection.

The tapered nose may be comprised of a ferrous alloy, e.g., steel.

The tapered nose may be comprised of a non-ferrous alloy, e.g., a copper alloy or a titanium alloy.

Further features and aspects of example embodiments of the present invention are described in more detail below with reference to the appended Figures.

### BRIEF DESCRIPTION OF THE DRAWINGS

FIG. 1 shows a side view of an aeration tine in accordance with example embodiments of the present invention.

FIG. 2 shows a cross-sectional view of the aeration tine shown in FIG. 1.

FIG. 3 shows an enlarged view of section B of FIG. 2.

FIG. 4 shows a body or base portion of the aeration tine shown in FIG. 1.

FIG. 5 shows a top view of the base portion shown in FIG. 4.

FIG. 6 shows a cross sectional view of the base portion taken along section A-A of FIG. 5.

FIG. 7 shows a side view of the base portion shown in FIG. 4.

FIG. 8 shows an end view of the base portion shown in FIG. 4.

FIG. 9 shows a nose cap or cone of the aeration tine shown in FIG. 1.

FIG. 10 shows a cross-sectional view of the nose cap shown in FIG. 9.

FIG. 11 shows a partial cross-sectional view of an aeration tine in accordance with example embodiments of the present invention having a threaded connection.

FIG. 12 shows results of testing of aeration tines.

FIGS. 13 to 15 show photomicrographs showing case depth microstructure of aeration tines in accordance with example embodiments of the present invention.

FIGS. 16 to 18 shows a photomicrograph showing case depth microstructure of an aeration tine in accordance with related art.

FIG. 19 shows a photomicrograph of a sample core microstructure of an aeration tine in accordance with example embodiments of the present invention.

FIG. 20 shows a photomicrograph of a sample core microstructure of an aeration tine in accordance with related art.

### DEFINITIONS

As used herein, the terms “boriding” and “boronizing” are used interchangeably and indicate the development of a boron-containing layer on a metal substrate, such that boron diffuses into the metal and reacts with a component of the metal or a component of the metal diffuses to the boron-containing layer and reacts with the boron, or both. Similarly, as used herein, the term “boronized” is used to describe a material, part, or assembly that has been subjected to boriding or boronized as defined above.

As used herein, the terms “non-borided” and “non-boronized” are used interchangeably and indicate a material that has not been exposed to boriding. Moreover, these terms, as used herein, also encompass materials having a trivial or insubstantial development of a boron containing layer, in particular where such layer is 0.001″ thickness or less.

As used herein, the term “effective case depth” indicates the perpendicular distance from the surface of a hardened case to the deepest point at which a HV of 1000 Vickers or greater is attained.

### DETAILED DESCRIPTION

In certain embodiments, the present invention provides an aeration tine 1 that is comprised of an elongated longitudinal tubular body 100 having a reduced-diameter connection shaft and a tapered nose. Although this illustrated example is hollow, it should be understood that the aeration tine may be hollow or solid. The shaft end connects the aeration tine device to the aeration machine. Multiple aeration tine devices are usually attached to an aeration machine. The aeration machine repeatedly inserts the tine aeration device into the ground to aerate the turf of lawns, athletic fields and golf courses.

The aeration tine device is fabricated from steel. The elongated longitudinal tubular body is fabricated separately from the tapered nose and both have a self locating step which is grooved. On the elongated longitudinal tubular body it is on the non-shaft end. On the tapered nose it is on the opposite side of the tip section. The self locating step on the elongated longitudinal tubular body and tapered nose assist in lining up and connecting together the two parts when welded. The grooved sections also help to ensure a consistent weld.

The elongated longitudinal tubular body may be formed of the same material or a different material with respect to the nose. Accordingly, the longitudinal tubular body may be formed of any material described herein with regard to the nose, or any other suitable material. Similarly, it should be understood that the materials discussed herein in connection with the longitudinal body and the nose should not be considered limiting; rather, one of ordinary skill in the art should understand that any suitable material or materials may be provided in accordance with example embodiments of the present invention.

After fabrication, the elongated longitudinal body may optionally be heat treated, and the tapered nose is borided separately from the elongated longitudinal tubular body. Boriding the tapered nose separately from the elongated longitudinal tubular body alleviates the weight stress on the tine aeration device. As a result, there is no resulting shape distortion as compared to when the entire aeration tine device is borided as one piece. The tapered nose and elongated longitudinal tubular body then are matched together on a welding machine, such as a precision welding lathe, and the system rotates the two parts around their centerline and a weld is produced around the outer surface of the aeration tine device. There are many types of welding techniques which can be used to create the circumferential weld that brings the elongated longitudinal tubular body and tapered nose together—for example, tungsten inert gas (TIG), plasma, and/or friction welding. The resulting aeration tine device is allowed to cool. The parts are then heat treated under inert conditions to achieve the appropriate bulk hardness.

Heat treatment of the longitudinal body, which is formed of, e.g., bulk steel, makes the material harder and stronger and less susceptible to yield to the stress of soil insertion. Heat treatment of the borided nose reduces the likelihood of the borided layer from spalling.

Heat treating of the longitudinal body and the tapered nose together may provide advantages over heat treating the longitudinal body and the tapered nose separately prior to attaching the longitudinal body to the tapered nose. For example, if the longitudinal body and the tapered nose are welded together, the welding may result in a heat affected zone which would be annealed and thus not as strong.

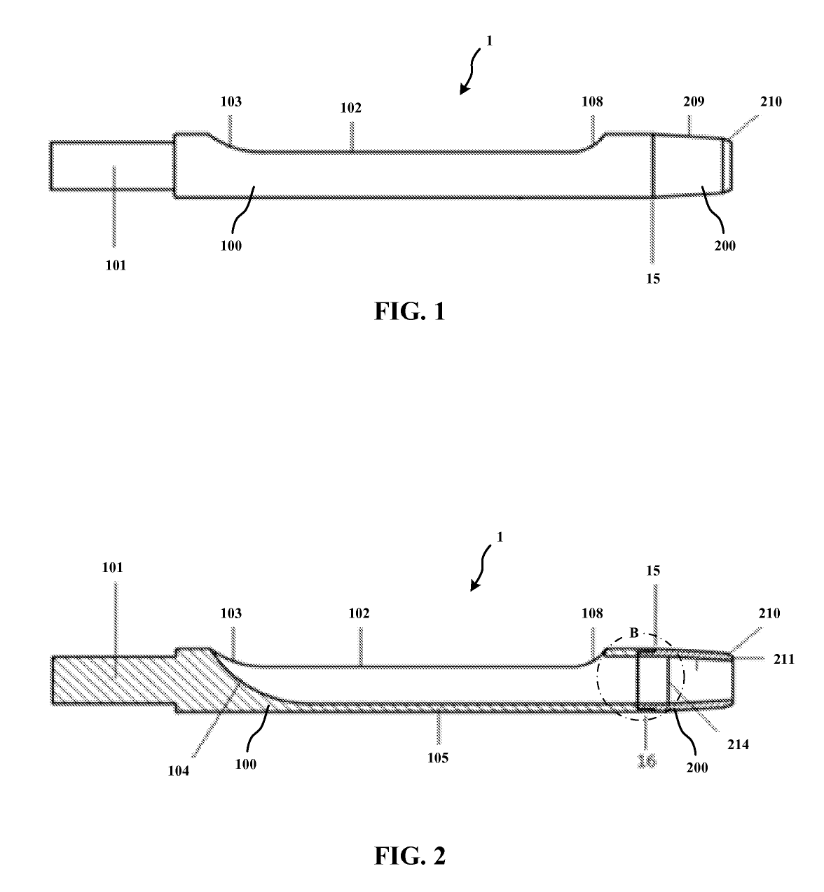

FIG. 1 shows an aeration tine 1 in its complete fully manufactured form. The complete tine 1 is composed of two distinct parts—a body 100 and a nose cap 200—which are joined together during the manufacturing process.

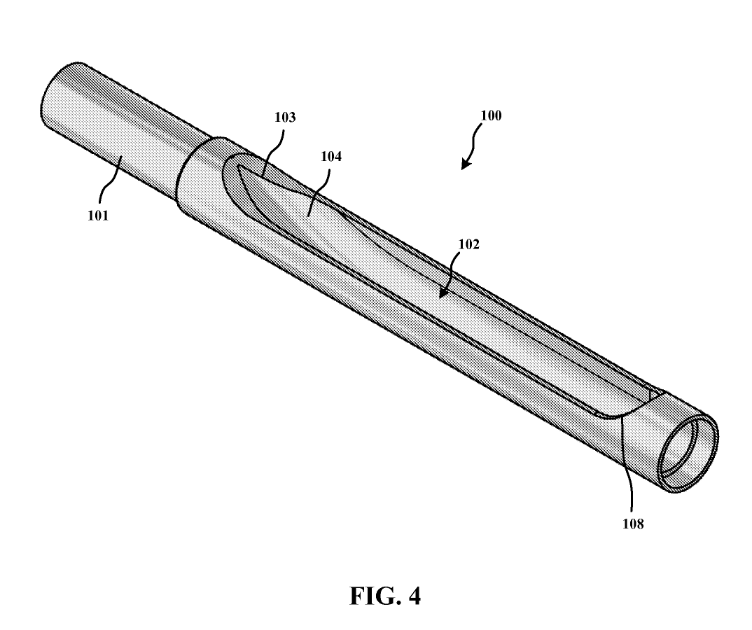

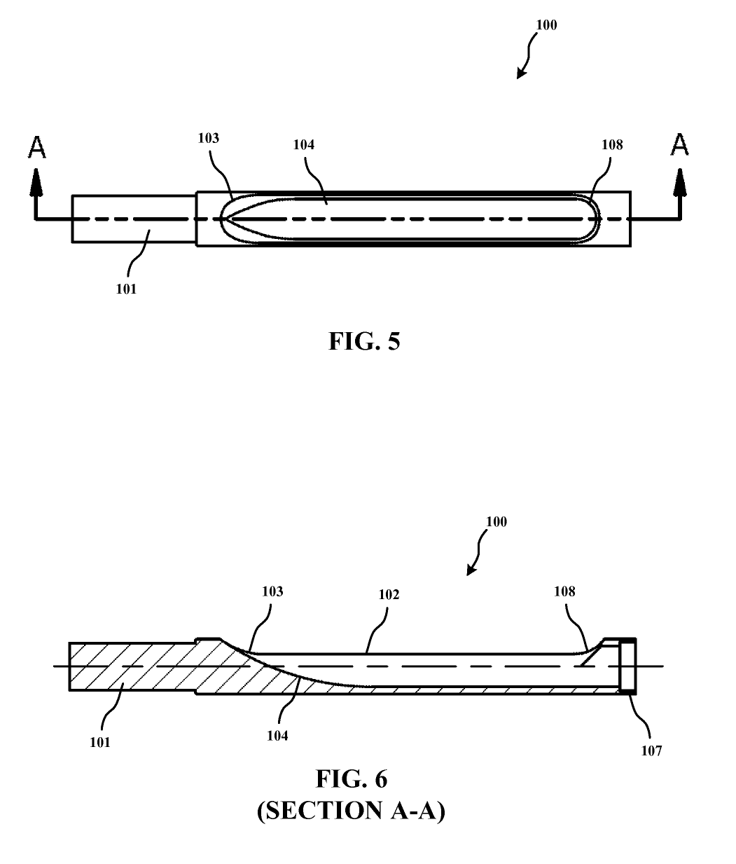

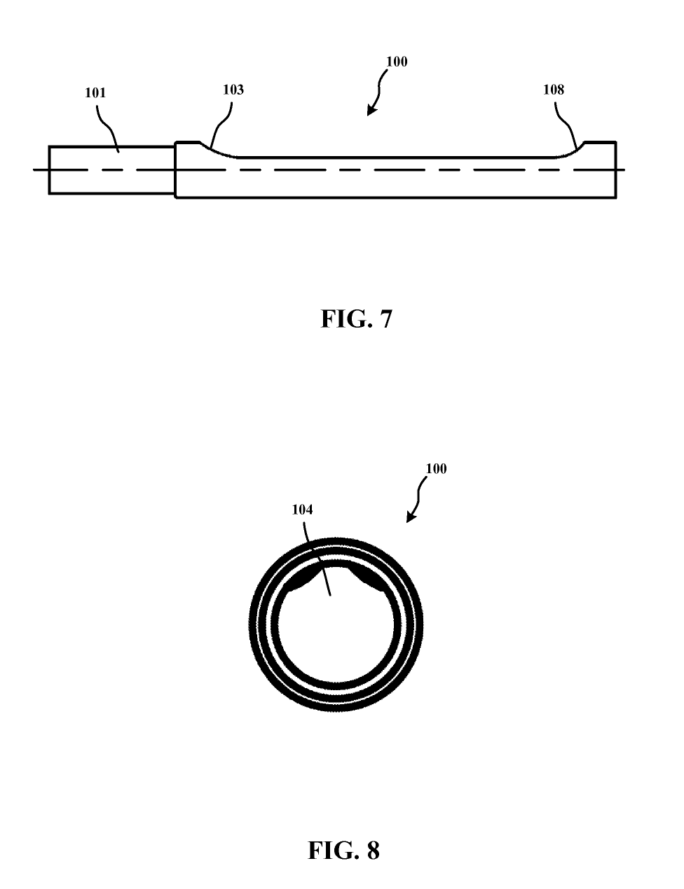

FIGS. 4 to 8 show the body 100 of the tine 1.

In this example, the body 100 is responsible for connecting to aeration machines, e.g., tractor pulled or walk-behind aeration machines, as well as ejecting the core that is taken from the ground. The illustrated example includes a mounting shaft 101 disposed at a proximal end of the body 100 and suitable to be received in an aeration machine to support the tine 1 therefrom. The mounting shaft 101 may vary in size depending, e.g., on the size of the tine needed. Although the mounting shaft 101 in the illustrated example has a reduced diameter relative to other portions of the body 100, it should be understood that the mounting shaft 101 may be the same diameter or a larger diameter than other portions of the body 100.

The body 100 also includes an ejection window 102 in the form of a longitudinal opening along one side of the body 100. This window 102 is where the core is ejected once it is pulled from the ground. The window 102 may vary in size depending on the desired core size.

The window 102 includes a proximal tapered portion 103 and a distal tapered portion 108. Referring to the cross-sectional view of FIG. 6, the interior profile of this example of a hollow tine 1 includes an internal curved surface profile 104 that allows the core to be deflected and therefore be ejected from the ejection window 102.

Portion 105 refers to a region of relatively constant wall thickness along the length of the body 100 along the area in which the core is received in the body 100 prior to engaging the curved profile 104. It is the thickness of this portion 105 that is able to be minimized in accordance with embodiments of the present invention in comparison to known boronized tine devices. Moreover, this wall thicknesses may vary depending on, e.g., the type of soil the tine is intended to aerate.

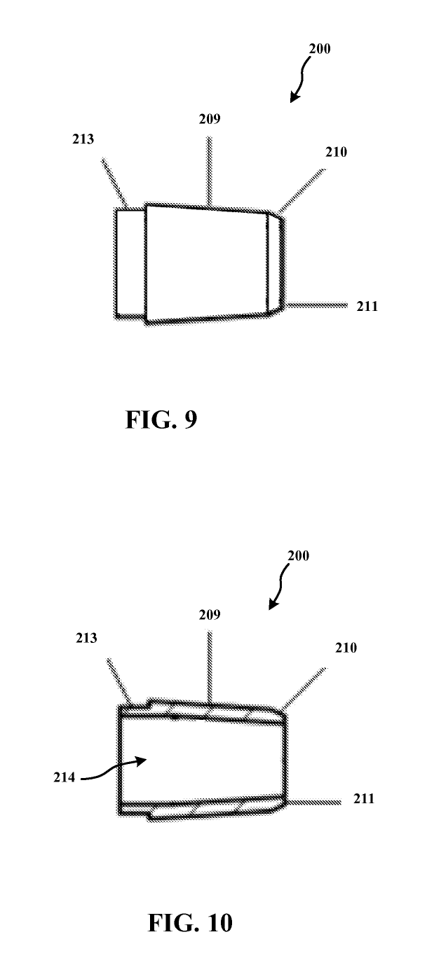

FIGS. 9 and 10 show the nose cap 200 of the tine 1.

The nose cap 200 includes a first tapered portion 209 that extends along a majority of the axial length of the nose cap 200, and a second tapered portion 210 disposed distally of the first tapered portion 209 and having a sharper taper than the first tapered portion 209. The tapered portions 209 and 210 enhance the ability of the tine to cut into the ground evenly.

The nose cap 214 has a hollow inner portion 214 having a cross-section that decreases toward the distal end of the nose cap 200. This results in the interior clearance between a plug of soil and the tine 1 increasing as the plug progresses proximally with respect to the tine. This facilitates ejection of the plug without clogging the window. The nose cap 200 and the body 100 meet at an attachment interface 15, as illustrated in FIGS. 1 to 3. At this interface 15 the tapered profile of the nose 200 meets the non-tapered body 100. On the inside of the tine 1, there is step down 16 that has been created. This step down has been created by milling down an annular or circular ring from the inner diameter of the body 100 and then milling down an annular or circular ring from the outer diameter of the nose cap 200 to create an interlocking engagement. For the nose cap, an extra length of material is included at the proximal end that will interact with the body specifically for the purpose of milling the outer ring down.

Due to the way the boron treatment is performed, the step down of the nose cap is milled down until there is a slight gap in the connection between the body and the nose. This gap allows for metal expansion due to the boronizing treatment process.

Once the nose cone has been treated by the boronizing process, the body 100 and the nose cap 200 are connected by plugging them into each other to form the interlocking engagement at the step down 16. The entire body-nose part combination 100, 200 is then welded together at the point of contact 15 between the two initial pieces 100 and 200.

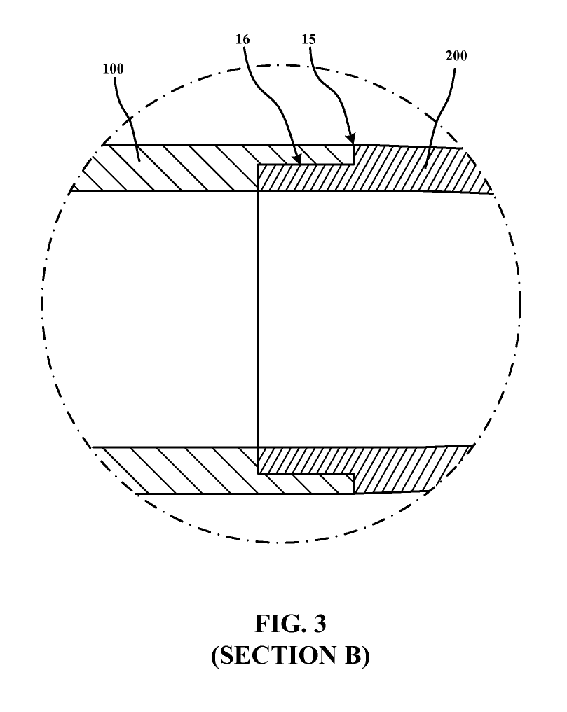

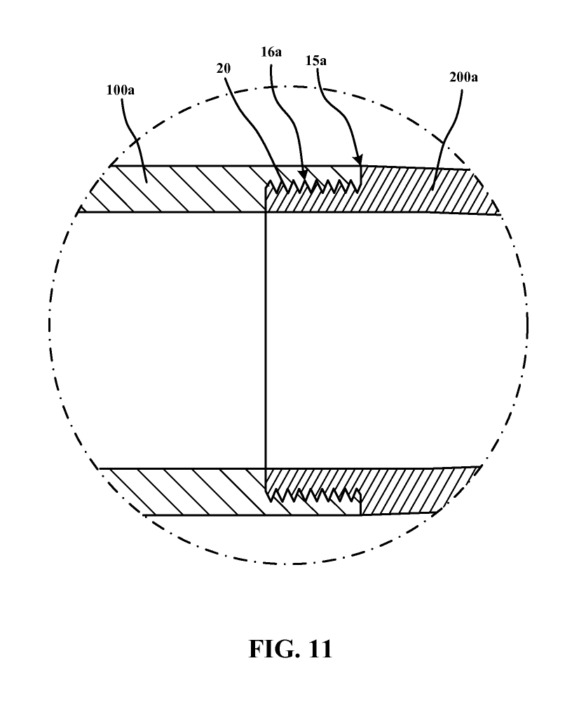

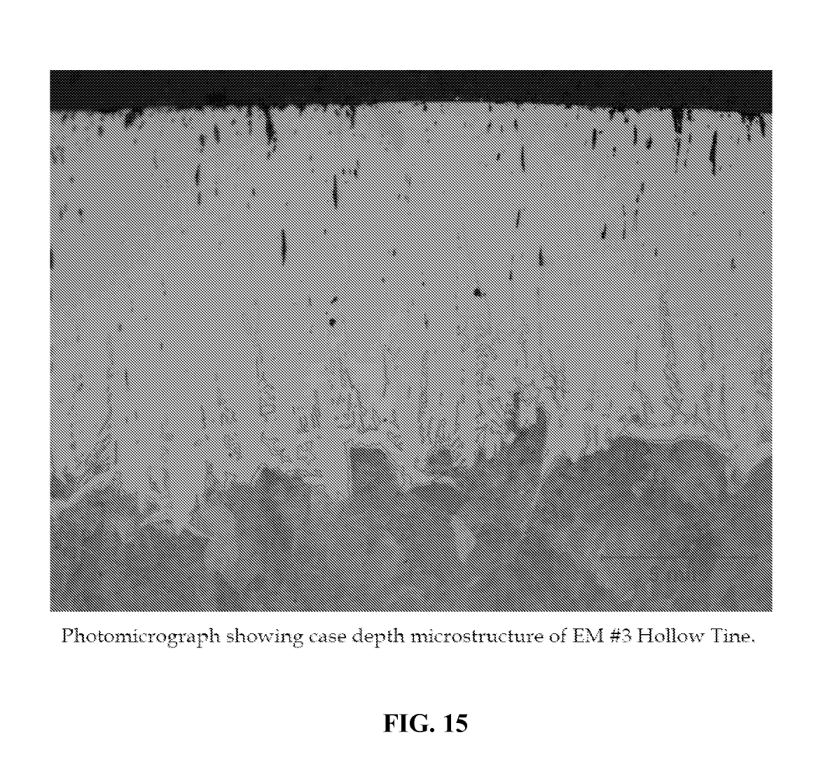

FIG. 11 shows another aeration tine having the same features of the aeration tine 1 except that the body 100a engages the nose cap 200a via a threaded connection 20. The sectional view of FIG. 15 is analogous to the section shown in FIG. 3 with respect to the tine 1. As shown in FIG. 11, the nose cap 200a has been screwed onto the body 100a such that respective threaded surfaces of the nose cap 200a and the body 100a engage each other at the step down 16a. The threading engagement may provide secure the nose cap 200a to the body 100a with or without additional securement mechanisms. Such optional additional securement mechanisms may include, for example, a permanent or non-permanent adhesive applied to the threaded connection 20 to prevent unintended loosening of the threaded connection 20 during use, and/or a weld, braze, and/or solder applied at the external contact line 15.

In accordance with some embodiments, the threaded nose cap 200a may be removable and by unscrewing the threaded nose cap 200a from the body 100a. This may allow for replacement of the threaded nose cap 200a with, e.g., another threaded nose cap 200a by screwing the replacement threaded nose cap 200a to the body 100a. This may be advantageous to allow for replacement of caps 200a when they become worn or damaged, without replacing the entire tine.

It should be understood that there exist implementations of other variations and modifications of the invention and its various aspects, as may be readily apparent to those of ordinary skill in the art, and that the invention is not limited by specific embodiments described herein. Features and embodiments described above may be combined in various ways. It is therefore contemplated to cover any and all modifications, variations, combinations or equivalents that fall within the scope of the basic underlying principals disclosed and claimed herein.

### EXAMPLES

### Example 1

### Boronization of Tine Nose and Comparative Testing

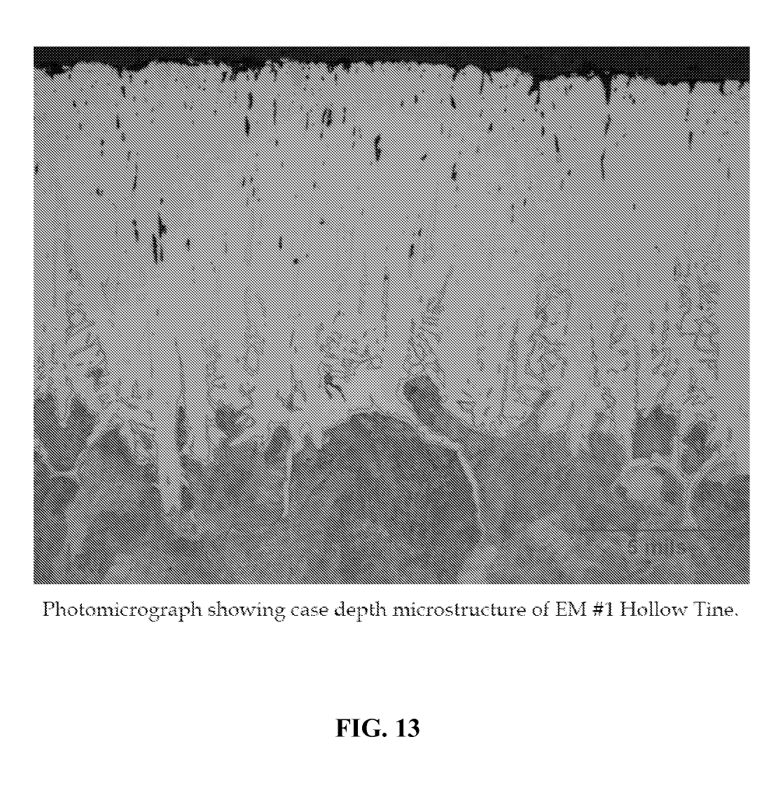

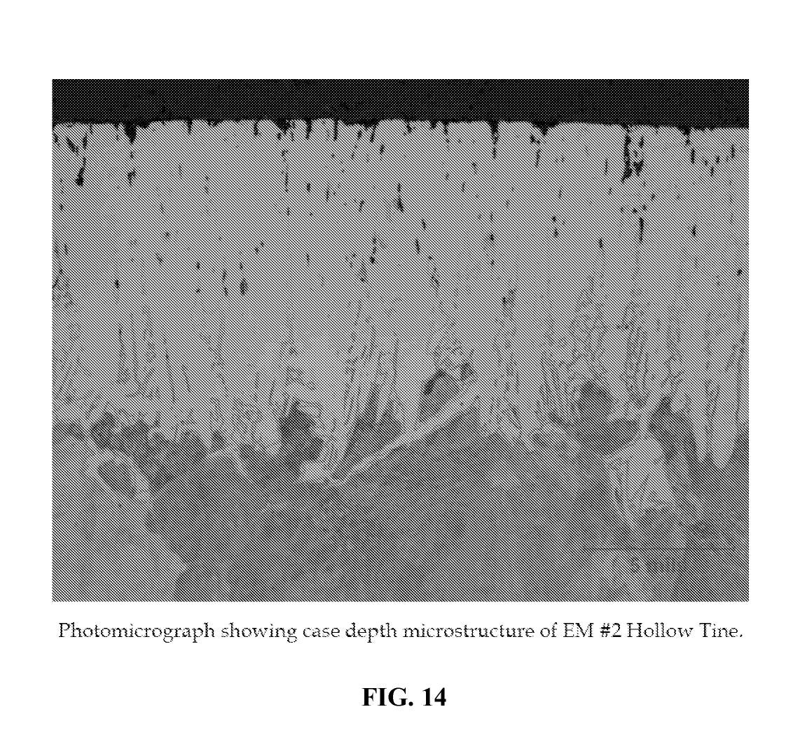

For each of three samples in accordance with example embodiments of the present invention, a tine nose was borided by pack boriding. The samples were borided for 18 hours at 1800° F. Micrographs of the boride layer, showing the sawtooth pattern frequently observed in borided steels, are shown in FIGS. 13 to 15. The three samples had effective case depths of 0.0135″, 0.0145″, and 0.0105″, respectively. HV₅₀ was measured (ASTM E 384-99^{E1}, Vickers indenter, 50 g load) at a depth of 0.0015″ below the surface to be 1683 Vickers, 1832 Vickers, and 1595 Vickers, respectively.

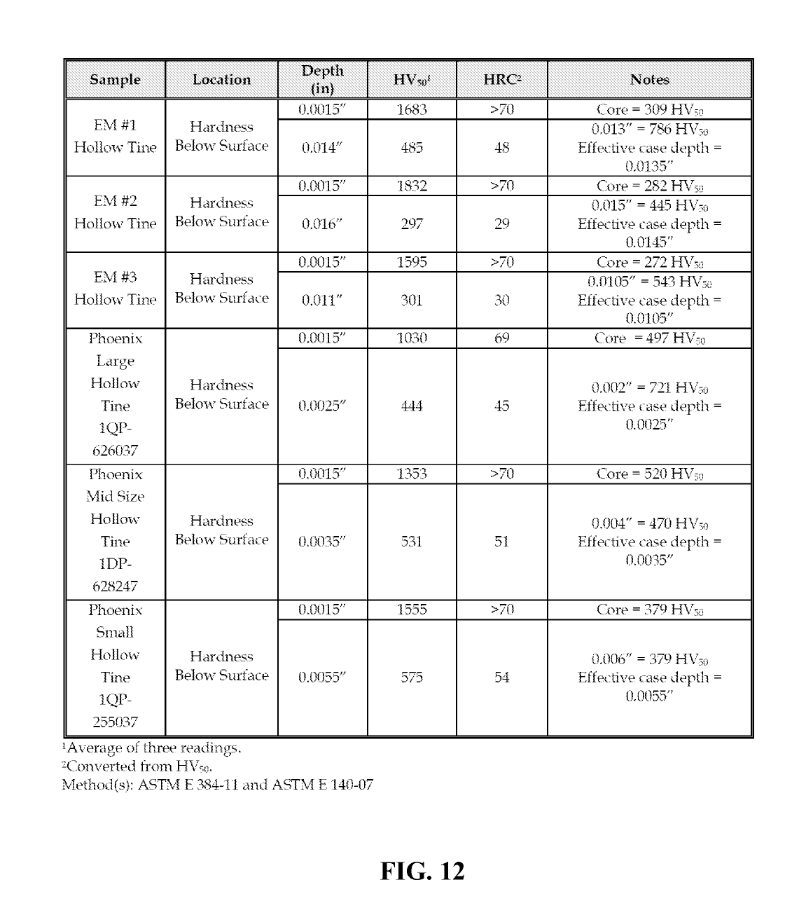

FIG. 12 is a graph of HV₅₀ for borided tines, measured across a cross section of samples prepared to a 1 micron final polish, including the three aforementioned samples.

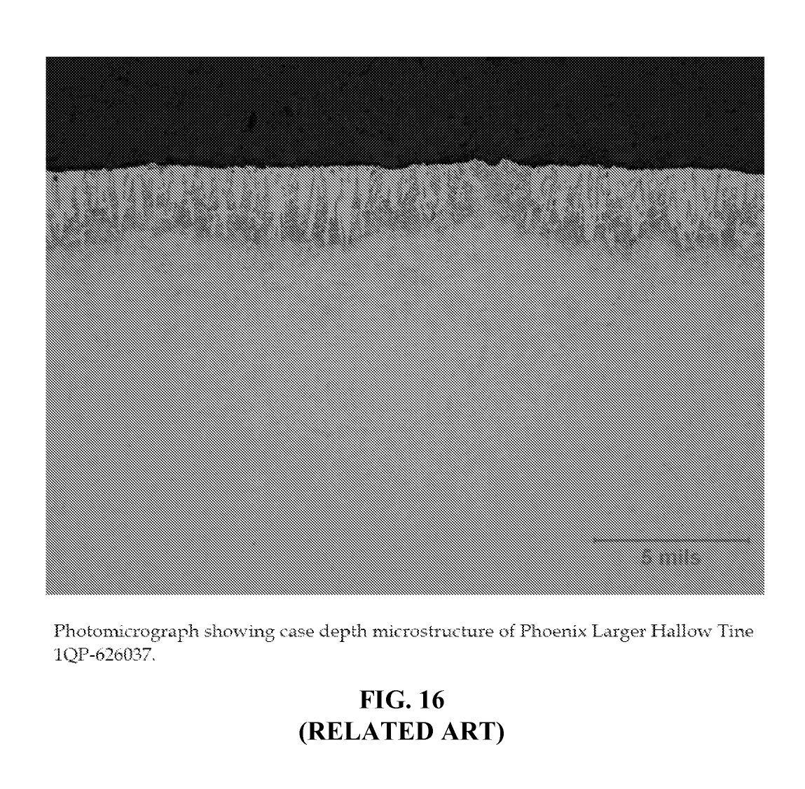

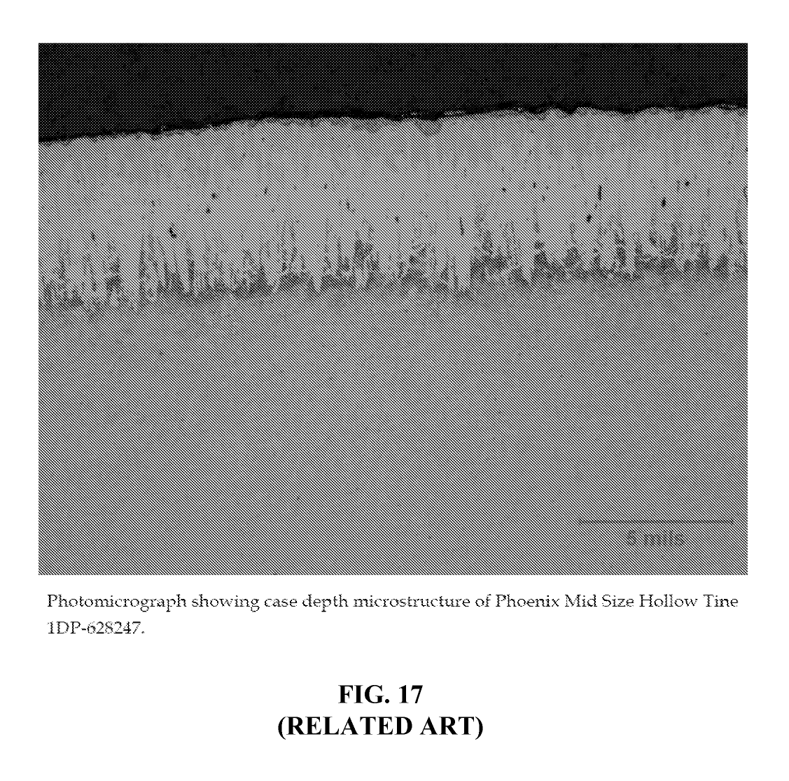

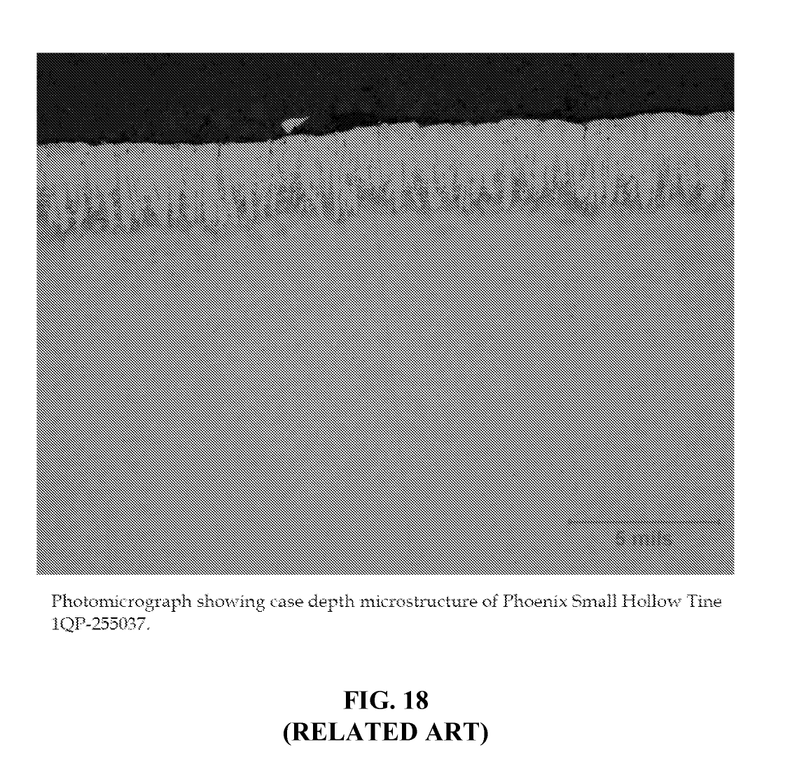

For comparison, three commercially available borided aeration tines marked under the Phoenix™ brand by Ceres Turf, Inc. were tested as well, the results being shown in FIG. 12. Also for comparison, microphotographs showing case depth microstructure of these comparative samples were taken and are reproduced in FIGS. 16 to 18.

The larger “1QP-626037” Phoenix™ hollow tine had a 0.650 outer diameter, a 0.520-inch inner diameter, and a 0.065-inch wall thickness. The mid-sized “1DP-628247” Phoenix™ hollow tine had a 0.625 outer diameter, a 0.396-inch inner diameter, and a 0.072-inch wall thickness. The smaller “1QP-255037” Phoenix™ hollow tine had a 0.360 outer diameter, a 0.260-inch inner diameter, and a 0.050-inch wall thickness.

The three samples prepared in accordance with the present invention were prepared to like specifications, with a 0.360-inch outer diameter, a 0.260-inch inner diameter, and a wall thickness of 0.050 inches.

Each of the six samples was sectioned approximately one half inch from the sharp distal end, mounted, polished, and microhardness tested at outside diameter surface for effective case and the end of diffused case. Core microhardness was also tested.

The microphotographs were obtained by mounting a section of each sample, in epoxy, metallographically prepared to a 1-micron final polish, etched using a 2% nital solution, and examined using a light optical microscope at magnifications up to 1000×.

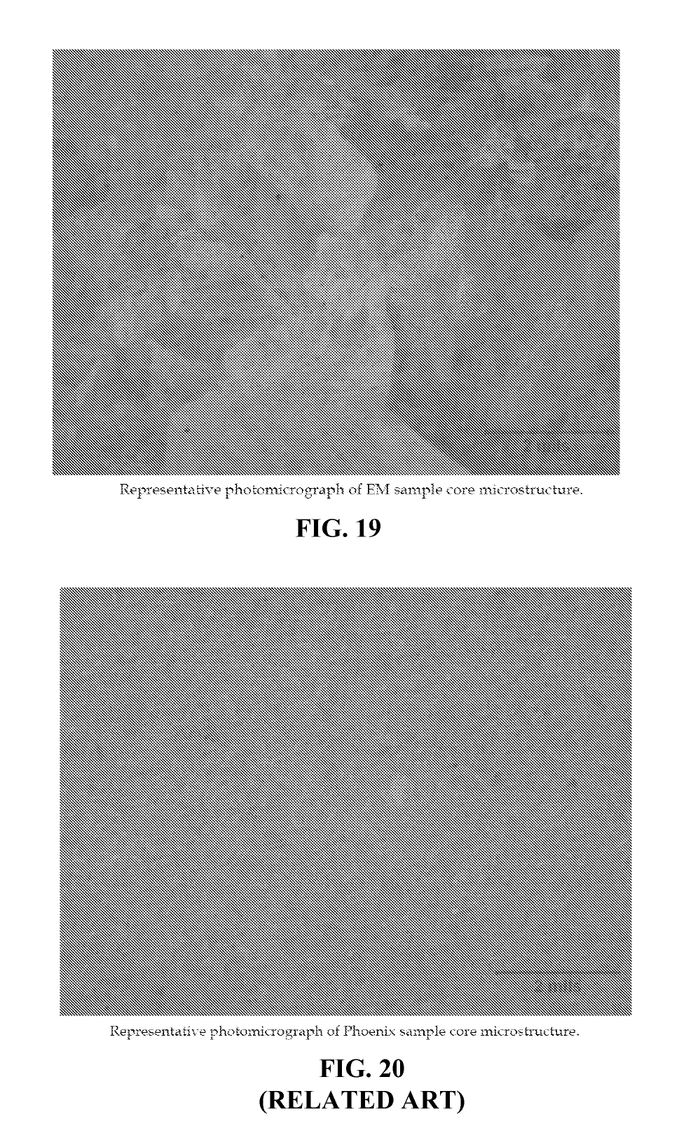

The EM Hollow Tine sample's core microstructure is a pearlite/ferrite mix, as illustrated in FIG. 19, and the Phoenix™ samples have a core microstructure of tempered martensite, as illustrated in FIG. 20.

### Example 2

### Welding of Tine

A Tine nose and body are cleaned properly and aligned such that inner set in the nose piece fits into the opening in the body. The two parts are held in place and rotated in a Tungsten Inert Gas (TIG) welding machine and welded together. The parts are allowed to cool. The newly welded tine is then heat treated under inert conditions to achieve the appropriate bulk hardness.

What is claimed is:

1. An aeration tine, comprising:
a non-boronized elongated body including a first longitudinal end configured to support the tine relative to an aeration machine, and a second longitudinal end opposite the first longitudinal end; and
a tapered nose attached to the second longitudinal end of the non-boronized elongated body, the tapered nose formed of a metal base treated by a boronization process such that the tapered nose has a an outer layer that is hardened relative to an inner portion of the metal base.

2. The aeration tine of claim 1, wherein the non-boronized elongated body is heat treated.

3. The aeration tine of claim 1, wherein the nose is heat treated.

4. The aeration tine of claim 1, wherein the entire aeration tine is heat treated.

5. The aeration tine of claim 1, wherein the metal base is comprised of a ferrous alloy.

6. The aeration tine of claim 5, wherein the ferrous alloy is steel.

7. The aeration tine of claim 1, wherein the metal base is comprised of a non-ferrous alloy.

8. The aeration tine of claim 1, wherein the tapered nose is welded to the non-boronized elongated body.

9. The aeration tine of claim 1, wherein the tapered nose is brazed or soldered to the non-boronized elongated body.

10. The aeration tine of claim 1, wherein the tapered nose is fixedly attached to the non-boronized elongated body.

11. The aeration tine of claim 1, wherein the tapered nose is attached to the non-boronized elongated body via a threaded connection such that the tapered nose is screwed onto the non-boronized elongated body.

12. the aeration tine of claim 1, wherein the first longitudinal end includes a shank having a reduced diameter relative to other portions of the non-boronized elongated body, the shank configured for insertion into an aeration machine.

13. The aeration tine of claim 1, wherein the aeration tine is hollow.

14. The aeration tine of claim 13, wherein the non-boronized elongated body includes a longitudinal opening for ejection of soil plugs during an aeration process.

15. The aeration tine of claim 1, wherein the aeration tine is not hollow.

16. An aeration machine configured to aerate soil, the aeration machine comprising:
an aeration tine according to claim 1.

17. A method, comprising:
aerating soil with an aeration tine according to claim 1.

18. A method of making an aeration tine, comprising:
boronizing a metal tapered nose such that the tapered nose has a an outer metal layer that is hardened relative to an inner metal portion of the tapered nose; and
attaching the boronized tapered nose to a second longitudinal end of a non-boronized elongated body, the non-boronized elongated body having a first longitudinal end configured to support the tine relative to an aeration machine, the first longitudinal end being disposed opposite the second longitudinal end.

19. The method of claim 18, further comprising heat treating the boronized tapered nose and the non-boronized elongated body after the boronized tapered nose and the non-boronized elongated body are connected.

20. The method of claim 18, wherein the attaching the boronized tapered nose to a second longitudinal end of a non-boronized elongated body comprises welding the boronized tapered nose to the non-boronized elongated body.

21. The method of claim 18, wherein the attaching the boronized tapered nose to a second longitudinal end of a non-boronized elongated body comprises brazing or soldering the boronized tapered nose to the non-boronized elongated body.

22. The method of claim 18, wherein the attaching the boronized tapered nose to the second longitudinal end of a non-boronized elongated body includes screwing the boronized tapered nose onto the non-boronized elongated body via a threaded connection.

23. The method of claim 18, wherein the tapered nose is comprised of a ferrous alloy.

24. The method of claim 23, wherein the ferrous alloy is steel.

25. The method of claim 18, wherein the tapered nose is comprised of a non-ferrous alloy.
